(19) United States
(12) Patent Application Publication
(10) Pub. No.: US 2007/0151037 A1
(43) Pub. Date: Jul. 5, 2007

(54) Active unsaturated esters, method for the production thereof, and use of the same

(75) Inventors: Laurence Feruccio, Vert Le Grand (FR); Helene Ierno, Bretigny Sur Orge (FR)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Isochem, Paris (FR)

(21) Appl. No.: 10/586,881

(22) PCT Filed: Jan. 20, 2005
(86) PCT No.: PCT/FR05/00123

§ 371 Date: Jan. 3, 2007

(30) Foreign Application Priority Data
Jan. 23, 2004 (FR) 04/00666

(51) Int. Cl. C11D 3/00

(52) U.S. Cl. 8/115.51

(57) ABSTRACT

The invention relates to a compound of formula (I) wherein X represents an activating radical such as a chlorine atom or imidazoyl, Y represents a saturated aliphatic C₆-C₂₀ radical, and Z represents an aliphatic C₂-C₁₀ radical. The invention also relates to a method for synthesising the compound of formula (I), according to which the compound of formula (II) is formed by the reaction between an alcohol and an acid anhydride, and by the activation of the carbonyl function. Furthermore, the invention relates to the use of the compound of formula (I) for increasing the hydrophobic character of polymers comprising amine and/or hydroxyl functions by means of grafting, and to a support based on natural textile fibres onto which the compound of formula (I) is grafted.

The present invention relates to novel activated unsaturated esters which, by grafting, especially allow an increase in the hydrophobic nature of functional polymers.

Polymers do not always have surface properties ideally suited to their final use (biomedical field, adhesion, separation techniques, etc.). Grafting is a technique for directly or indirectly attaching, via covalent bonding to the surface of a polymer, one or more molecules chosen for their specific properties. Grafting thus modifies the surface chemistry of the polymer and hence its surface behavior. The polymer thus has novel, better suited properties.

It is known that the physicochemical properties of functional polymers may be modified by grafting chemical molecules onto these polymers. Depending on the nature of the grafted molecule, the hydrophilic or hydrophobic properties of the polymer will be modified, and, furthermore, the reactivity of the grafted polymer may also be modified if said chemical molecule contains functional groups capable of reacting.

Those skilled in the art are always in search of novel molecules that can be grafted onto a functional polymer to modify its hydrophobic nature and/or its reactivity.

The present invention concerns compounds of formula (I) 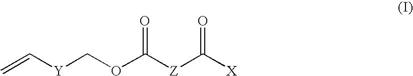
in which:
X represents a group that activates the α-carbonyl function;
Y represents a linear or branched, saturated C₆-C₂₀ aliphatic radical, optionally substituted with one or more C₁-C₁₀ alkoxy radicals; and
Z represents a linear or branched, saturated or unsaturated C₂-C₁₀ aliphatic radical.

For the purposes of the present invention, the term “activating group” means an electron-withdrawing group or an electronegative group having a withdrawing inductive effect and/or a withdrawing mesomeric effect. This electron-withdrawing or electronegative group thus allows the electrophilic nature of the α-carbonyl group to be increased. This activating group can, firstly, increase the electrophilicity of the carbonyl, and thus its reactivity, and, secondly, stabilize the anion obtained by the loss of this group. The activating group is also generally a good leaving group.

Examples of activating groups that may especially be mentioned include halogens (which will then give an acid halide), carboxylates (which will then give an acid anhydride), phenols optionally substituted with one or more electron-withdrawing groups, substituted hydroxylamines or nitrogenous heterocycles such as imidazole or tetrazole. However, in the context of the present invention, the alkoxy radicals are not activating groups.

In the context of the present invention, the term “activated carbonyl function” will denote the carbonyl function of the compound of formula (I) that is alpha to the activating group.

For the purposes of the present invention, the term “unsaturated aliphatic radical” preferably means an alkenyl radical.

According to one variant of the invention, X represents a halogen atom, in particular chlorine, bromine or fluorine, and more advantageously a chlorine atom. On account of the instability of acid iodides, it is preferred not to use compounds in which X represents an iodine atom. When X represents a chlorine, bromine or fluorine atom, it activates the α-carbonyl function via a withdrawing inductive effect.

According to another variant of the invention, X represents an activating group chosen from the group consisting of a conjugated nitrogenous heterocyclic radical, such as the imidazolyl radical, a radical R—C(O)—O—, such as the pivaloyloxy radical, a radical R—O—C(O)—O—, in which R represents a linear or branched, saturated or unsaturated C₁-C₆ alkyl radical, such as a tert-butyl, isobutyl, isopropenyl or neopentyl radical.

Y advantageously represents a radical —(CH₂)ₙ— in which n is from 6 to 20 and advantageously 6 to 15. In the context of the present invention, Z advantageously represents a C₂-C₆ aliphatic radical and even more advantageously an aliphatic radical chosen from the group consisting of —(CH₂)₂—, —(CH₂)₃—, —CH₂—CH(CH₃)—CH₂— and —CH₂—C(CH₃)₂—CH₂— radicals. An advantageous compound according to the present invention is a compound for which Z represents an aliphatic radical —(CH₂)₃— and Y represents an octanediyl radical, of formula —(CH₂)₈—. The compound that is preferred according to the present invention is pentanedioic acid monoundec-10-enyl ester monochloride, also called the monoundec-10-enyl ester of pentanedioic acid monochloride, of formula:

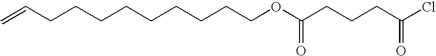

The compound according to the invention, of formula (I), is particularly advantageous due to the fact that its two ends are then capable of reacting with functional compounds. Specifically, the activated carbonyl function and the vinyl bond are highly reactive.

The present invention also concerns, as intermediate products, compounds of formula (II) 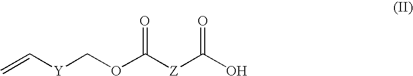
in which
Y represents a linear or branched, saturated C₆-C₂₀ aliphatic radical, optionally substituted with one or more C₁-C₁₀ alkoxy radicals; and
Z represents a linear or branched, saturated or unsaturated C₂-C₁₀ aliphatic radical.
Y advantageously represents a radical —(CH₂)ₙ— in which n is from 6 to 20 and advantageously 6 to 15. In the context of the present invention, Z advantageously represents a C₂-C₆ aliphatic radical and even more advantageously an aliphatic radical chosen from the group consisting of —(CH₂)₂—, —(CH₂)₃—, —CH₂—CH(CH₃)—CH₂— and —CH₂—C(CH₃)₂—CH₂— radicals. An advantageous compound according to the present invention is a compound for which Z represents the aliphatic radical —(CH₂)₃— and Y represents an octanediyl radical, of formula —(CH₂)₈—. The compounds of formula (II) are used as intermediate products for the manufacture of the compounds of formula (I). The carboxylic acid function, which is not reactive enough to react especially with amine and/or hydroxyl functions of polymers, for example, is then activated.

The present invention also relates to a process for synthesizing the compound of formula (I) according to the invention, characterized in that it comprises the following successive steps:
a) formation of an acid of formula (II) via acylation reaction of an alcohol of formula (III)
   H₂C═CH—Y—CH₂—OH (III)
   with an acid anhydride of formula (IV) 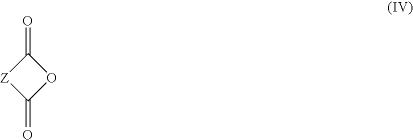
   in which Y, Z and n have the same meanings as those given for formula (I);
b) formation of the product of formula (I) via substitution of the —OH radical of the acid of formula (II) with a radical X, in which X has the same meaning as that given for formula (I).

The synthetic reaction of step a) is advantageously performed by mixing the acid anhydride of formula (IV) and the alcohol of formula (III) at a temperature of between 80 and 120° C. Following this mixing, the reaction medium is advantageously maintained at a temperature of between 70 and 120° C. for a period generally ranging from 30 minutes to 5 hours.

The acid anhydride of formula (IV) is advantageously chosen from the group consisting of succinic anhydride, glutaric anhydride, 3-methylglutaric anhydride and 3,3-dimethylglutaric anhydride.

According to one variant of the invention, X represents a halogen atom, preferably chlorine, bromine or fluorine and even more advantageously a chlorine atom. When X represents a chlorine atom, a chlorinating agent chosen from the group consisting of phosgene, diphosgene, triphosgene, thionyl chloride and oxalyl chloride is advantageously used in step b). When the chlorinating agent is phosgene, diphosgene or triphosgene, a catalyst chosen from the group consisting of disubstituted N,N-alkylamides such as dimethylformamide, and preferably diisobutylformamide or dibutylformamide, is used.

According to another variant of the invention, X represents an activating group chosen from the group consisting of a conjugated nitrogenous heterocyclic radical, such as an imidazolyl radical, a radical R—C(O)—O—, such as a pivaloyloxy radical, a radical R—O—C(O)—O—, in which R represents a linear or branched, saturated or unsaturated C₁-C₆ alkyl radical, such as a tert-butyl, isobutyl, isopropenyl or neopentyl radical. When X represents such a group, the hydroxyl radical of the acid of formula (II) may be substituted during step b) via reaction with an acid chloride or a chloroformate or via reaction with carbonyldiimidazole when X represents an imidazolyl radical.

The present invention also relates to the use of compounds of formula (I) for increasing the hydrophobic nature of polymers comprising amine functions by reacting said amine functions with the activated carbonyl function of the compounds of formula (I) to form amide bonds. A partially or totally grafted polymer whose hydrophobicity is increased is thus obtained. The vinyl bond may then react with another monofunctional or polyfunctional compound.

The compound of formula (I) may thus be used for waterproofing and/or steam-permeabilizing natural textile fibers, especially wool or silk fibers, comprising amine functions, via formation of amide bonds between said amine functions of the natural textile fibers with the activated carbonyl function of the compound of formula (I).

The grafting, of the compound of formula (I), may be performed according to known techniques, for example by dipping.

In parallel or in conjunction, the present invention also relates to the use of a compound of formula (I), for increasing the hydrophobic nature of polymers comprising hydroxyl functions by reacting said hydroxyl functions with the activated carbonyl function of said compound of formula (I) to form an ester bond. A partially or totally grafted polymer whose hydrophobicity is increased is thus obtained. The vinyl bond may then optionally react with another monofunctional or polyfunctional compound.

The grafting, of the compound of formula (I), may be performed according to standard techniques.

Thus, the compound of formula (I) may be used to modify the reactivity of oligosaccharides by grafting. For example, the sucrose unit of formula: 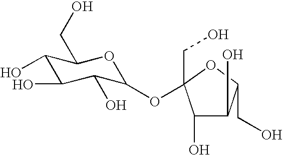
may be modified by partial reaction in aqueous media of the compound of formula (I), especially of pentanedioic acid monoundec-10-enyl ester monochloride, with the sucrose unit, the hydroxyl functions of which are not protected, followed by grafting by reaction with the vinyl bond of silanes comprising at least one −Si—H function to give impermeabilizing surfactants.

In particular, sucrose, the hydroxyl functions of which are unprotected, may be esterified by adding the compound of formula (I), for example pentanedioic acid monoundec-10-enyl ester monochloride, with stirring, to an aqueous sucrose solution, advantageously containing 60% by weight of sucrose relative to the total weight of the mixture, adjusted to a basic pH, advantageously of about 10, by adding a sodium hydroxide solution.

Finally, the present invention relates to a support based on natural textile fibers comprising hydroxyl and/or amine functions onto which is grafted at least one compound of formula (I) according to the invention, via formation of an ester and/or amide bond with said hydroxyl and/or amine functions of said support, with the exception of supports based on cellulose fibers. The natural textile fibers are advantageously silk or wool fibers.

The compound of formula (I) may be grafted onto said support via any grafting technique known to those skilled in the art, for instance solvent grafting or dipping. For example, if said support is a textile material, patent FR 693 803 describes a process in which this textile material is immersed in a solution comprising an esterifying agent, in an apolar solvent that is neutral with respect to the textile material, and it is then pressed, dried and finally subjected for about 6 hours to a temperature above 35° C., preferably to a temperature of between 70 and 100° C.

The example that follows illustrates the present invention without, however, limiting its scope.

### EXAMPLE

### Process for Synthesizing Pentanedioic Acid monoundec-10-enyl ester monochloride

1 mol of glutaric anhydride (C₅H₆O₃, M=114.1 g/mol) is placed at room temperature, i.e. about 25° C., into a reactor. This glutaric anhydride is heated to a temperature of 95° C. and one mole of undecenol (C₁₁H₂₂O, M=170.3 g/mol) is then added rapidly, at this temperature of about 95° C. During the addition of the undecenol, the temperature of the mixture drops to about 75° C. The mixture is then heated to a temperature of 110° C. Strong exothermicity is observed at the start of heating, and care must be taken to ensure that the temperature of the mixture does not exceed 120° C. The mixture is maintained at a temperature of 110° C. for 1 hour 30 minutes.

The acid having the formula below is thus obtained:

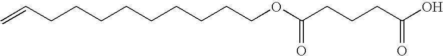

This acid is then converted into the acyl chloride by phosgenation.

0.07 mol % of the catalyst diisobutylformamide is added to the mixture obtained above, still maintained at a temperature of 110° C., followed by addition of 1.5 molar equivalents of phosgene. The mixture thus obtained is then maintained at a temperature of 110° C. until the evolution of hydrogen chloride gas has ceased, i.e. about 1 hour 30 minutes.

This mixture is then cooled to a temperature of 40-45° C. and the nitrogen is then degassed at a temperature of 40-45° C. Finally, the degassed mixture is cooled to a temperature of 20-25° C.

Pentanedioic acid monoundec-10-enyl ester monochloride is obtained in a molar yield of 98%. The compound thus obtained is a brown liquid. The conformity of the structure of the compound obtained is confirmed by identification by ¹H NMR spectroscopy. The purity of the compound, measured by argentimetry, is 97.7 w/w %.

1-19. (canceled)

20. A compound of formula (I) 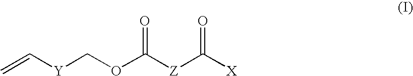
in which X represents a group that activates the α-carbonyl function;
Y represents a linear or branched, saturated C₆-C₂₀ aliphatic radical, and
Z represents a linear or branched, saturated or unsaturated C₂-C₁₀ aliphatic radical.

21. The compound as claimed in claim 20, wherein Y represents a saturated C₆-C₂₀ aliphatic radical substituted with one or more C₁-C₁₀ alkoxy radicals.

22. The compound as claimed in claim 20, wherein X represents a chlorine, bromine or fluorine atom.

23. The compound as claimed in claim 22, wherein X represents a chlorine.

24. The compound as claimed in claim 20, wherein X represents an activating group chosen from the group consisting of a nitrogenous heterocyclic radical, a radical R—C(O)—O and a radical R—O—C(O)—O—, in which R represents a linear or branched, saturated or unsaturated C₁-C₆ alkyl radical.

25. The compound as claimed in claim 20, wherein Z represents an aliphatic radical chosen from the group consisting of —(CH₂)₂—, —(CH₂)₃—, —CH₂—CH(CH₃)—CH₂— and —CH₂—C(CH₃)₂—CH₂—.

26. The compound as claimed in claim 20, wherein Z represents the aliphatic radical —(CH₂)₃— and Y represents an octanediyl radical, of formula —(CH₂)₈—.

27. A process for synthesizing the compound of formula (I) as claimed in claim 20, comprising the following successive steps:
a) formation of an acid of formula (II) 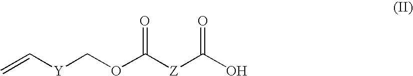
via acylation reaction of an alcohol of formula (III)
H₂C═CH—Y—CH₂—OH (III)
with an acid anhydride of formula (IV) 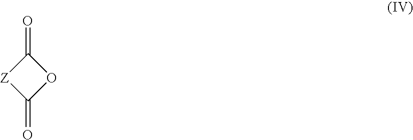
in which Z, Y and n have the same meanings as those given for formula (I);
b) formation of the product of formula (I) via substitution of the —OH radical of the acid of formula (II) with a radical X, in which X has the same meaning as that given for formula (I).

28. The process as claimed in claim 27, wherein the synthetic reaction of step a) is performed by mixing, at a temperature of between 80 and 120° C., the acid anhydride of formula (IV) and the alcohol of formula (III).

29. The process as claimed in claim 27, wherein, following said mixing of the acid anhydride of formula (IV) and the alcohol of formula (III), the temperature of the reaction medium is maintained at a temperature of between 70 and 120° C.

30. The process as claimed in claim 27, wherein the acid anhydride of formula (IV) is chosen from the group consisting of succinic anhydride, glutaric anhydride, 3-methylglutaric anhydride and 3,3-dimeth7ylglutaric anhydride.

31. The process as claimed in claim 27, wherein X represents chlorine.

32. The process as claimed in claim 31, wherein, in step b), a chlorinating agent chosen from the group consisting of phosgene, disphosgene, triphosgene, thionyl chloride and oxalyl chloride is used.

33. The process as claimed in claim 32, wherein when the chlorinating agent is phosgene, diphosgene or triphosgene, a catalyst chosen from the group consisting of disubstituted N,N-alkylamides is used.

34. The process as claimed in claim 27, wherein X represents an activating group chosen from the group consisting of a nitrogenous heterocyclic radical, a radical R—C(O)—O and a radical R—O—C(O)—O—, in which R represents a linear or branched, saturated or unsaturated C₁C₆ alkyl radical.

35. A method, for increasing the hydrophobic nature of polymers comprising amine functions comprising a step of reacting said amine functions with compound of formula (I) to form an amide bond.

36. The method as claimed in claim 35, for waterproofing and/or steam-permeabilizing natural textile fibers, especially wool or silk fibers.

37. A method for increasing the hydrophobic nature of polymers comprising hydroxyl functions by reacting said hydroxyl functions with compound of formula (I) to form an ester bond.

38. A method for modifying the reactivity of oligosaccharides by grafting compound of formula (I) onto at least one hydroxyl function of said sucrose via formation of an ester bond.

39. A support based on natural textile fibers comprising hydroxyl and/or amine functions onto which is grated at least one compound of formula (I) via formation of an ester and/or amide bond with said hydroxyl and/or amine functions of said support, with the exception of supports based on cellulose fibers.

40. The support as claimed in claim 39, wherein the natural textile fibers are silk or wool fibers.
